(19) United States
(12) Patent Application Publication
(10) Pub. No.: US 2002/0031207 A1
(43) Pub. Date: Mar. 14, 2002

(54) User editable database to forward communications sent to an unified assess number to caller-specific destinations

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 09/839,714

(22) Filed: Apr. 19, 2001

Related U.S. Application Data
(60) Provisional application No. 60/198,308, filed on Apr. 19, 2000.

(51) Int. Cl. H04M 1/64

(52) U.S. Cl. 379/88.17

(57) ABSTRACT

The present invention discloses a communication network system. The communication network system includes a message routing means for controlling and delivering a telephonic message to a plurality of destinations. The network communication system further includes a database for providing an unified access number and a forwarding destination number to the message routing means for forwarding a telephone message sent to the unified access number to the forwarding destination number. And, the database further includes a user interface means for a telephone user to edit the unified access number and the forwarding destination number to the database.

This Application claims a priority date of Apr. 19, 2000 benefited from a previously filed Provisional Patent Application No. 60/198,308 filed on Apr. 19, 2000 by the Applicant of this Formal Patent Application.

### BACKGROUND OF THE INVENTION

1. Field of the Invention

This invention relates generally to systems for telephonic and electronic mail communications. More particularly, this invention relates to an improved system-configuration and method for enabling a user to control a sender-specific message forwarding program by interactively editing a database table through an Internet. A telephone and an Internet user is enabled to instantaneously instruct a telephonic message-routing device and an electronic mail server a sender-specific sequence, telephone numbers, or e-mail addresses to forward incoming calls or electronic mails.

2. Description of the Prior Art

As commented in US News and World Report published on Mar. 6, 2000, that technology is always complicating life in an effort to simplify it. The new article continues with the observation that the ability to work from anywhere sounds great until the need to juggle scads of numbers, such as office phone, home phone, cell phone, pager, fax, and then different e-mail addresses for different accounts use for different purposes. The article then reported that there are several Internet services to provide Web sites allow for unified messaging. The Web sites are set up to resolve the problems by simplifying and, to certain degree, unifying the message delivering processes. Examples of such unified messaging sites include www.onebox.com, www.messageclick.com, and www.jfax.com. The theme is to provide universal in-box on the Web to deliver faxes, e-mails, and voice mails.

These Internet services for unified messages still face several limitations and difficulties. As a user signs up with these services, a telephone number is assigned. A fax sent to this number is routed to a private Web page or e-mail account that the user can access. Voice mails work the same way by that the audio message is sent to a private Web site or as e-mail that a user can download and play using an audio player. However, According to the news report, since the service is not available in certain areas, the phone number assigned to a user may be of a different area code than where the user resides or works. Meanwhile for an incoming telephone call, a caller has to wait for the unified access provider to first check with a user to first ask if the user is available or willing to answer the call. A caller to that unified access number can easily get frustrated for the long pauses.

As a matter of facts, various telephonic technologies already provide some solutions to the message delivery limitations. A telephone number can be easily applied for receiving an incoming telephone call or a fax transmission. Call forwarding options are available to forward the call to an office telephone or pager. Such operations can even be remotely operated. As far as telephonic communications are concerned, a user is provided with some resources and flexibility to unify the message delivery processes to certain extent if a telephonic user decide to do so. The major issues often encountered are mostly due to other concerns such as the consideration of privacy that a telephone user may not want to provide the home phone numbers in exchanging a business card. A home phone number, pager number or a cellular phone number are typically revealed to only limited number of peoples when necessary. For the consideration of privacy, the “unified messaging” services, have not yet resolved the problems and concerns now encountered by common telephone users. For that reasons, we all have to handle so many numbers even with the “unified messaging services” now available on the Internet as free sign-on Web sites.

For business operations, there is however a major trend that greatly adds to the complexities of message delivery. Specifically, more and more communications are now conducted on Internet with electronic mails (e-mails). The e-mail addresses for sending and receiving Internet communications become another important set of identifiers for message delivery. These e-mail addresses have different lengths and often comprise numbers and alphabets or even unusual characters. E-mail addresses usually can not easily remembered. Furthermore, as indicated above, each person may have several e-mail addresses for different accounts and different purposes. Access and message delivery become even more complex due to the situation of Intent communications. The unified messaging services discussed above do not seem to address this complexity that additional e-mail addresses now become another set of identifier associated with each personal now required to access and deliver messages.

In U.S. Pat. No. 5,930,348, Regnier, et al. disclose an “intelligent” telecommunication network for dynamically controlled routing of calls in intelligent networks. The intelligent network comprises a plurality of switching units interconnected by links and connected to a central computer unit. The central computer unit uses the destination address to identify the unsuccessful link and update the routing database to identify the link as unavailable. The central computer unit can further determine an alternate route for the call using different switches and nodes to deliver a call to the destination. The intelligent telecommunication network is useful to apply the database for changing message routes. However, such system is not available to the user to simplify the necessity to call several numbers to reach a person at different times and for different purposes. Even the technology is mature and useful, but such kinds of message routing technologies with flexible application of database are mostly employed in the context of network management for improving and optimizing message delivery performance. A consumer subscribed to a telephone service is not benefited from the system capabilities resulting from the significant advancements made in both computer and telecommunication technologies over past few decades.

Fleischer, III et al. disclosed in U.S. Pat. No. 5,592,541, entitled “Apparatus and Method for Forwarding Incoming Calls”, (issued Jan. 7, 1997), apparatus and method for forwarding incoming calls by utilizing a subscriber defined routing list. The routing list may comprise alternate telephone numbers to which calls placed to the subscriber's number(s) will be routed. Subscribers may establish routing lists that allow incoming calls to be forwarded to other numbers of either all of their numbers or for selected groups of one or more numbers. A unique group number identifies each group of numbers. Incoming calls are forwarded according to a time-of-day or day-of-week, a percentage allocation, a specific date, an originating location of the calling party, or inputs by the calling party to prompts. The subscribers may use the group number to activate and configure forwarding options associated with subscriber numbers associated with the group. The apparatus and method however are difficult to use because the subscribers are not provided with a convenient method to define the routing list. As shown in Fleischer III's FIGS. 12 through 17, a subscriber may make changes to the service logic by dialing a predetermined update telephone number established for updating forwarding features and options. The updating process is very awkward to implement because it requires the subscriber to hold on to the telephone set for long time to enter different kinds of numbers to select different options and calling groups. Because the operations are carried out using a telephone set interacting with “voice prompts”, such update processes are not user friendly and very time consuming. The usefulness of the intelligence for managing forwarding calls is greatly limited because of these difficulties.

Creamer et al. disclosed in U.S. No. Pat. 6,028,917, entitled “Access to Extended Telephone Services via the Internet” (issued Feb. 22,2000), a system to allow a predefined class of authorized users of public switched telephone network (PSTN) to access and extend telephone services through Internet. Authorized users in a predefined class can activate extended services through external networks without having to communicate with the telephone company representatives. Resource management intelligence of the PSTN is adapted to link to the external networks for communicating with and delivering extended telephone services to the authorized users. The extended services the authorized users can activate are call-waiting, caller ID, call forwarding, facsimile image transmittal, voice mail, etc. Internet Web interface is employed for the authorized users to activate and modify different types of extended services. The system can provide great deal of convenience and flexibility to control the phone calls. However, as that shown in FIGS. 1A to 1D, the system is more related to control and modify services provided to one registered telephone number. An authorized owner of that registered telephone number is enabled to add “extended” services related to that particular telephone number. The invention, even is very useful, however would not be able to resolve the real life difficulties that many different telephone numbers are to be maintained for each person. The difficulties arise from the facts that each telephone and Internet user usually can be reached at different locations with different telephone numbers or Internet addresses at different time of the day. Furthermore, this invention does not provide a solution to the issues that certain numbers are only for limited use by certain callers to protect privacy. The complexity of modern life arising from many different telephone numbers and e-mail addresses are not resolved by the patented invention of Creamer et al.

Telephone and Internet integration and the computer telephony technologies implemented over advanced intelligent network (AIN) controlled with Internet web-pages are disclosed in several U.S. Patents such as U.S. Pat. Nos. 6,031,904, 5,943,410, 5,958,016, 5,970,126, 6,011,794, 5,991,394, 6,012,088, 6,014,437, 6,018,761, and 6,021,126. According to these patents, the technology is mature for integration of computer and Internet control of telephone communications. Internet telephone communications are also available wherein the message routes can be conveniently controlled by computers through interface with database. However, since the implementations disclosed in these patents do not address the caller-specific switching control for unified access application, the modern telephone and Internet users, faced with the concerns of privacy protections, must maintain multiple numbers for conducting daily activities between several locations and different types of communication needs.

Therefore, a need still exists in the art of network for providing a new and improved configuration and method to overcome these limitations. The improved configuration and method must provide simplified and practical unified message delivery system to realize the unified access without spend too much efforts dealing with privacy issues. The new configuration and method must also enable a telephone user to send and receive e-mails without further complicating the message deliver processes.

### SUMMARY OF THE PRESENT INVENTION

It is therefore an object of the present invention to provide a system configuration and method to enable a user to control the linking and message delivery to different numbers through a unified access number. A database is provided that is interactively editable by a telephone user to enter caller-specific types of message routing paths and sequences for different types of messages. The re-editing of the database table is carried out by a telephone and Internet user through an initial registration and then by logging-in processes over an Internet to a control Web site. The editing data through control Web site is entered into a message routing database employed by a telephone message routing device to carry out the message routing processes according to the data entered into the database. A unified access number can therefore be employed to reach different phone numbers for telephones, fax, cellular phone, pager, and e-mail according to predefined routes and sequence such that the aforementioned difficulties and limitations can be resolved.

Another object of the present invention is to provide a new method and system configuration with a unified access management center provided with database accessible and editable by a registered Internet and telephone user. A register user to this unified access management center has a flexibility to change the forwarding telephone numbers and e-mail mail addresses by simply changing the database. The requirement to inform every telephone callers and e-mail correspondents about a change of phone numbers or e-mail address is no longer necessary. Additionally, the database also provide additional control for forwarding phone calls and e-mails to the unified access number to different numbers and e-mail address for different accounts depending on different callers and e-mail senders. The burden to provide and then keep track of different telephone numbers and e-mail addresses to different groups of people is therefore relieved because the user can now re-edit the database table to update caller-specific access. By re-editing the database, a telephone and Internet user is able to instantaneously change the routing of calls and e-mails received by the unified access number to different phone numbers and e-mail addresses.

Another object of the present invention is to provide a new method and system configuration to enable an automatic database updating process for communication message forwarding received by a unified access number. A network message router is connected to a database and enabled by the database to route the network message received by a unified access number to destination numbers or network addresses according to a forwarding sequence for each message sender list. An owner identification device such as a video camera linked to an image recognition processor is provided at certain networked computer-telephonic device. The owner identification device is employed to identify the presence of a owner assigned with the unified access number to automatically update the database to enhance the message forwarding processes to reach the owner for the messages sent to the unified access number.

Briefly, in a preferred embodiment, the present invention discloses a communication system network. The communication network system includes a message routing means for controlling and delivering a telephonic message to a plurality of destinations. The network communication system further includes a unified access management center. The unified access management center has a database for entering a unified access number and a plurality of caller lists. Each list is associated with a set of forwarding destination numbers for providing to the message routing means to forward a telephone message sent to the unified access number to the forwarding destination numbers. The unified access management center further includes an Internet-Web user interface means for a telephone user to edit the database for entering the unified access number and the forwarding destination numbers for the lists of callers. The unified access management center further includes a user-access control means for registering the telephone user in providing the unified access number to the database. The user access control means further includes a user-logging in means for logging in a registered telephone user for editing the database. The unified access management center further includes a telephone message processor for receiving the telephone message from the unified access number and for processing the telephone message as an electronic mail (e-mail) message.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIGS. 1A to 1D are functional block diagrams and flowcharts for showing the connections and conventional functional capabilities of public switched telephone network (PSTN) managed by intelligent switching control resource for providing extended call services;

FIG. 2 shows a functional block diagrams for illustrating a new configuration of a network communication system provided with unified access management center on the telecommunication network of this invention;

FIG. 3 is a exemplary database comprising lists of unified access numbers, forwarding destination numbers, caller numbers and forwarding codes for carryout different message delivery programs; and

FIG. 4 is a flow chart showing the functional steps carried out by the unified access management center to carry out message forwarding functions and programmable functions provided by the unified access management center.

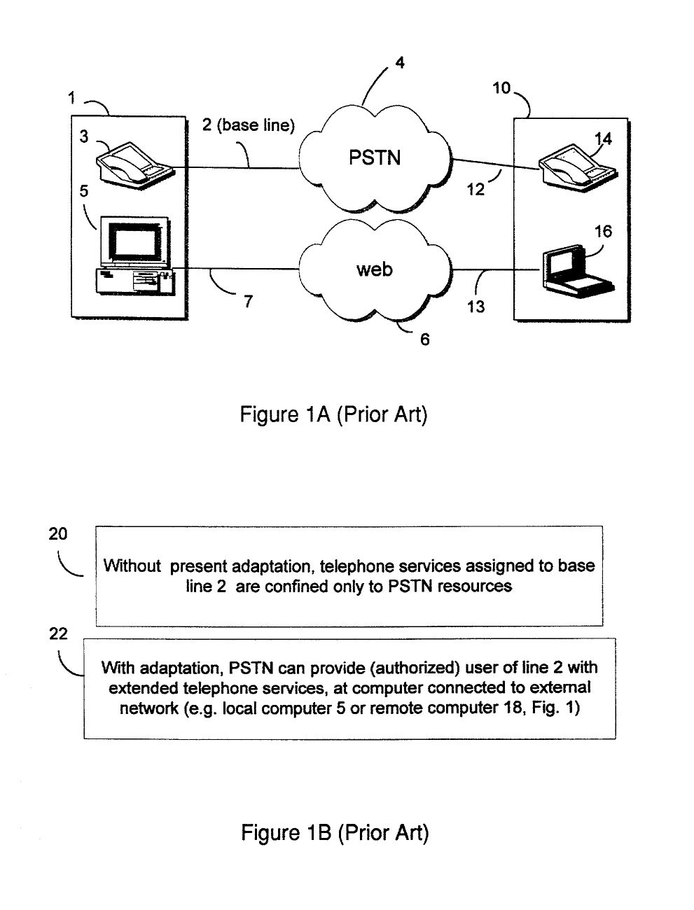

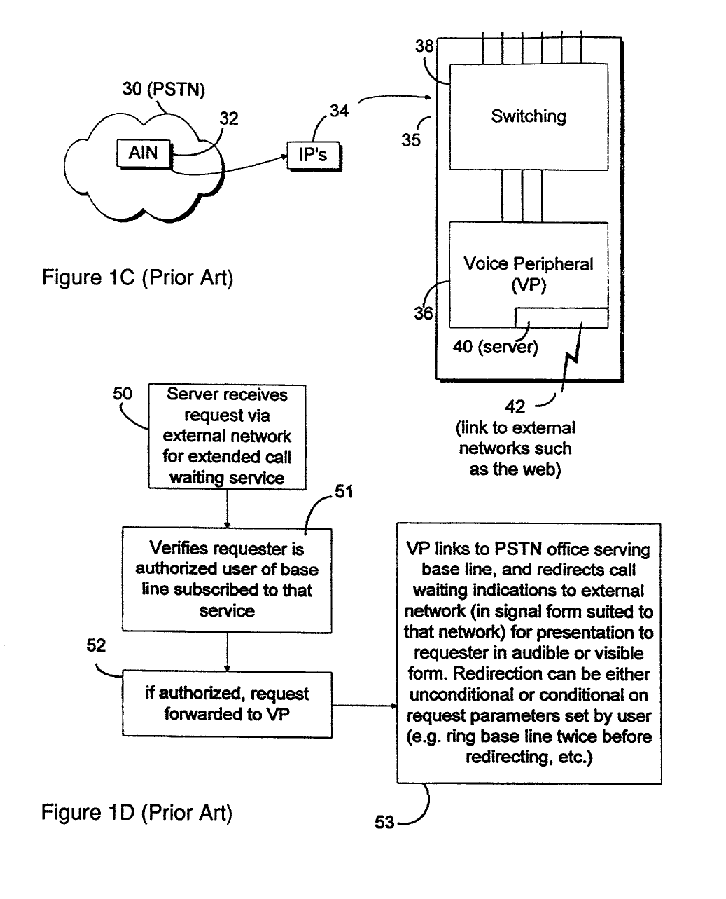

### DETAILED DESCRIPTION OF THE PREFERRED EMBODIMENT

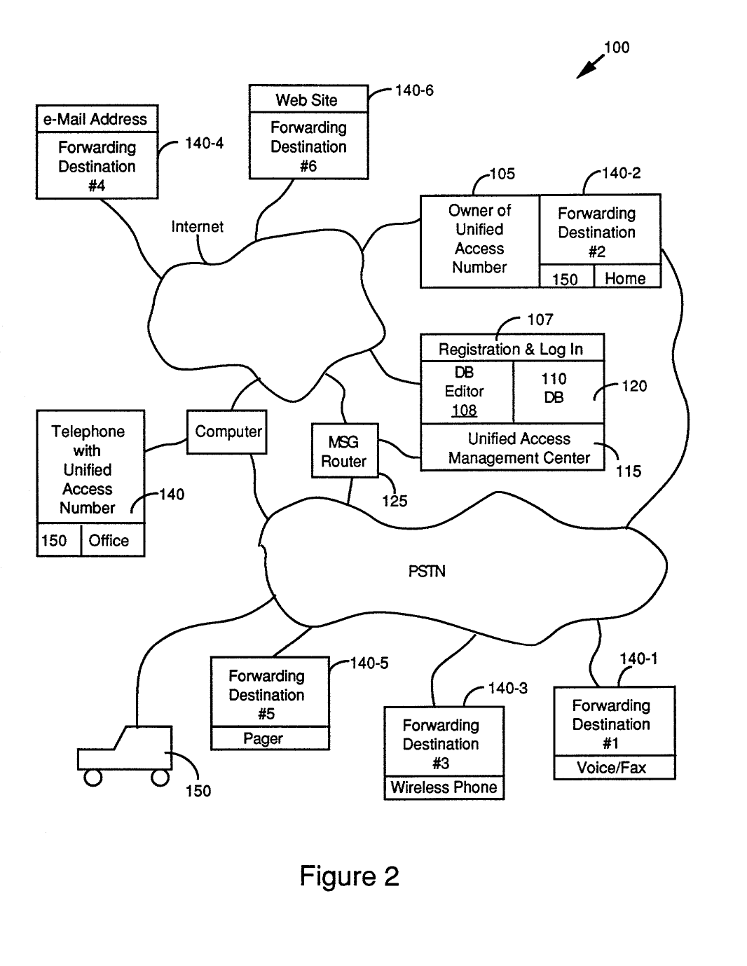

Referring to FIG. 2 for a functional block diagram showing an architecture overview of a system configuration for the present invention. The network communication system 100 is provided to a telephone and Internet user 105 to connect to a unified access management center 120 via telephone lines or other types of communication channels, e.g., wireless signal-transmission connections. The unified access management center 120 includes a registration and log-in processor 107 for registering the telephone or Internet user 105 to provide a unified access number, e.g., the primary office or home phone number, in FIG. 2 an office number is used. The registration and log-in processor may be a Web page on Internet to allow the telephone or Internet user to enter relevant information related to the unified access number and billing information to use the unified access services. After the telephone or Internet user 105 is properly registered, a database editor 108 for directing and controlling the message routing is presented to the telephone or Internet user 105 to enter relevant data into the database 110. Details of the message forwarding and routing data entered into the database 110 will be further described below. The database is then transmitted to a telephone message router 125 through an interface-module 115 of the unified access management center through data bus or other types of data transmission channels. The telephone or Internet user 105 is enabled to control the routing of a telephone call made to a unified access number 140-A by changing the database 110. Through the entries provided by the telephone or Internet user 105 to the database, the telephone calls made to the unified access number 140-A can be forwarded to forwarding destination number 1, 2, 3, etc. The message can be transmitted in different sequence at different time depending on the routing configuration entered by the telephone or Internet user 105. Additionally, the telephone or Internet user 105 may control the access to different forwarding destination numbers 140-1 (voice mail or fax), 140-2 (home), 140-3 (wireless phone), 140-4 (e-mail address), 140-5 (page), 140-6 (web site identified by an URL), etc., depending on what numbers the incoming calls are originated. Different callers may be assigned to different access groups for reaching the telephone or Internet users at different numbers. In a preferred embodiment, the unified access management center 120 may be constructed as a Web server. The Web server 120 is provided for processing the incoming phone calls as an e-mail or Internet file to send it to a forwarding destination number represent by an e-mail address or an universal resource locator (URL) on the Internet.

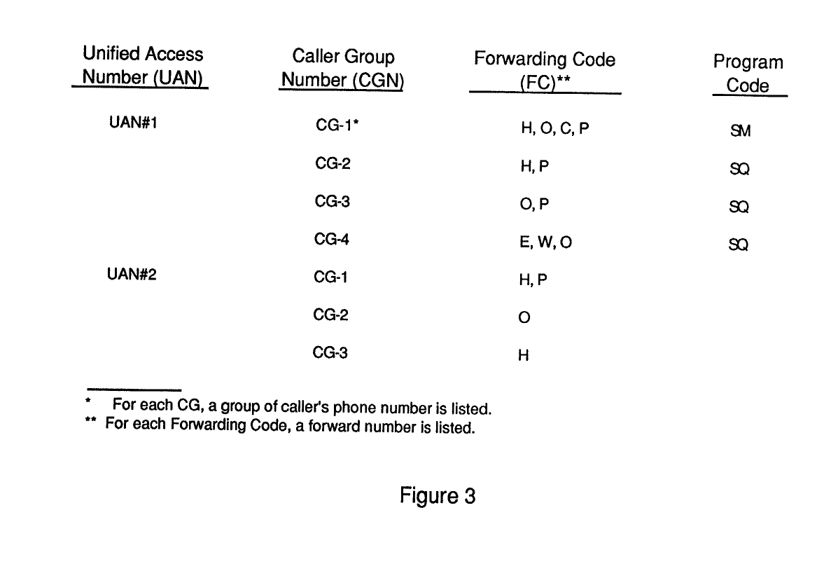

To further enhance the communication by calling the unified access number 140, a user presence identification device 150 is used in home, office, and car to identify the presence of the owner of the unified access number. The user's presence identification may be implement with a video camera and a simple identification verification processor to positively identify the presence of the owner of the unified access number. The user presence identification device 150 may be implemented on a cellular phone also by sending a database update signal when a user turns on the power of a cellular phone. Upon detecting the user's presence, a signal is sent to the unified access management center 120 to automatically update the database for forwarding the telephone call to the location where the user of this unified access number is located now. The unified access owner is not required to re-edit the database when there is a sudden change of schedule such as go home from earlier for particular reasons. A telephone call to the unified access number 140 will then be forwarded to the cellular phone in the car when the owner 105 is driving home and then forwarded to home when the user 105 arrives home and detected by the user presence identification device 150. The user presence identification device 150 thus enables the trace of the locations of the telephone or Internet user 105 as the user moves from one location to another location during a day. This location trace (LT) function can be programmed by design the database such that user's location trace only be allowed for certain caller groups to designated forwarding destination numbers at certain time period of the day. More details will be described in FIG. 3 below. For example, a location trace (LT) function would probably be allowed for all callers from 8:00 AM to 6:00 PM for a door to door salesman in response to callers requesting the goods advertised in a news paper. On the other hand, a person may allow for location trace (LT) at all time when the wife is due for the birth of a new baby at any time.

In a preferred embodiment, a personal computer 160 connected to the Internet can be configured and applied as a unified access management center. The personal computer 160 may have to provide certain user information to a telephone system administrator and to receive certain message routing instructions from a PSTN administrator for setting up a unified access management center. Some routing instruction to be sent to a controller for controlling a message router to route the calls made to the unified access number to different forwarding destination numbers are downloaded to the personal computer 160. The personal computer can interact with the telephone system rounter 125 to carry out the message forwarding processes according to the data provided in the database now stored in the personal computer 160. A telephone company administrates the controller of the message router 125 can monitor and keep track of the message forwarding operations for the purpose of computing telephone usage charges. Such configuration is even more convenient when the telephonic communication is handled as electronic mail audio files transmitted over the Internet.

Referring to FIG. 3 for a database table of this invention that is constructed by using data entered by the telephone or Internet user 105. The database table is arranged according to unified access numbers, erg., UAN#1, UAN#2, . . . UAN#X, etc. This unified access number is typically a primary number to reach a telephone or Internet user. Therefore, this unified access number is typically a home or office telephone number. Several caller groups, e.g., CG-1, CG-2, CG-3, etc., are then listed under each unified access number. Each caller group is provided with a forwarding code, e.g., H, O, C, P, E and W. Each code stands for a number to reach the telephone or Internet user. For example, H stands for home phone number, O stands for office phone number, C stands for cellular phone number and P stands for pager number, E stands for e-mail address, and W stands for web page. Each caller group is assigned different set of forwarding destination numbers (FDN). Associated with each caller group, a special program code (pc) may be assigned. Examples are F stands for pushing a F button for forwarding to a fax number to send fax, SM stands for simultaneously sending the telephone calls to all forwarding destinations at once and SQ stands for sending the telephone call to each forwarding destination sequentially. Other kinds of telephonic, or Internet programs may be encoded and assigned to different caller groups for controlling and directing the telephone communications made through the unified access number. The database thus enables a telephone or Internet user 105 to effectively and timely control the routing and reception of the incoming calls. A database editor 108 can be employed to provide user-friendly interface with a telephone or Internet user to re-edit the database 110 and update the message routing database 110. The database 110 presented in FIG. 3 is only an example for illustrating one actual implementation to carry out the invention of calling a unified access number 140 to reach several forwarding destination numbers, e.g., 140-1 to 140-6, predefined by a telephone or Internet user to reach that user 105.

According to FIGS. 2 to 3 and above descriptions, this invention discloses unified access telephonic communication system 100. The communication system includes a message routing means 125 for controlling and delivering a telephonic message to a plurality of destinations. The system further includes a unified access management center 120 that has a database 110 for entering a unified access number 140 and a plurality of caller lists. Each list is associated with a set of forwarding destination numbers for providing to the message routing means 125 to forward a telephone message sent to the unified access number 140 to the forwarding destination numbers, e.g., 140-1, 140-2, . . . , 140-6. The unified access management center 120 further includes an Internet-Web user interface means for a telephone user 105 to edit the database for entering the unified access number 140 and the forwarding destination numbers 140-1 to 140-6 for the lists of callers. The unified access management center 120 further includes a user-access control means 107 for registering the telephone user 105 in providing the unified access number 140 to the database 110. The user access control means 107 further includes a user logging in means for logging in a registered telephone user 105 for editing the database 110. The unified access management center 120 further has a telephone message processor 115 for receiving the telephone message from the unified access number and for processing the telephone message as an electronic mail (e-mail) message.

Additionally, a telephonic communication system is disclosed in this invention. The telephonic communication system includes a message routing means 125 for controlling and delivering a telephonic message to a plurality of destinations. The telephonic communication system further includes a database 110. The database provides to the message routing means 125 a unified access number 140 and a first forwarding destination number 140-1 to 140-6. Thus, it is allowed for a first list of callers to forward a telephone message sent to the unified access number from the first list of callers to the first forwarding destination number. The database 110 further includes a user interface means 107 for a telephone user 105 to edit the database 110 for entering the unified access number 140 and the first forwarding destination number for the first list of callers. In a preferred embodiment, the telephonic communication system further includes a unified access management center 120 for managing the database 110 and for controlling the user interface means 107. In a preferred embodiment, the unified access management center 120 further includes a user-access control means 107 for registering the telephone user in providing the unified access number 140 to the database. In a preferred embodiment, the unified access management center 120 further includes a user-logging in means for logging in a registered telephone user for editing the database 110. In a preferred embodiment, the database further includes at least a second forwarding destination number 140-2 associated with a second list of callers. The number and caller list are provided to the message routing means for further forwarding the telephone message received from the second list of callers received by the unified access number forwarded to the first forwarding destination number to the second forwarding destination number when the telephone message sent the first forwarding destination number is not answered. In a preferred embodiment, the unified access management center 120 further includes an Internet Web site provided for receiving and processing the telephone message from the unified access number as an electronic mail (e-mail) message. In a preferred embodiment, the unified access management center 120 further includes an Internet Web site and the Internet Web site comprising a user-access control means 107 for registering the telephone user to provide the unified access number 140 to the database. In a preferred embodiment, the database 110 further includes a forwarding sequence for each of the caller lists to forward the telephone message received by the unified access number from a caller in each of the caller list to forward the telephone message to different forwarding destination numbers according to the forwarding sequence of each of the caller lists. In a preferred embodiment, the database further includes a plurality of time-dependent forwarding sequences for each of the caller lists to forward the telephone message received by the unified access number from a caller in each of the caller list to forward the telephone message to different forwarding destination numbers according to the forwarding sequences in each of the caller lists based on a time of the day when the telephone message is received. In a preferred embodiment, the message routing means 125 further includes a database enabled sequential forwarding means to forward the telephone message sent to the unified access number sequentially to each of the forwarding destination numbers according to the forwarding sequence for each of the caller lists. In a preferred embodiment, the message routing means 125 further including a database enabled simultaneous forwarding means to forward the telephone message from a caller in a simultaneous forwarding caller list simultaneously to all of the forwarding destination numbers list in the database. In a preferred embodiment, the database further includes at least a forwarding destination e-mail address 140-4 for providing to the message routing means for forwarding the telephone message sent to the unified access number to the forwarding destination e-mail address. In a preferred embodiment, the database further includes at least a forwarding destination universal resource locator (URL) for providing to the message routing means for forwarding the telephone message sent to the unified access number to the forwarding destination URL 140-6. In a preferred embodiment, the telephonic communication system further includes a user presence identifying means for identifying a user's presence at a location of one of the forwarding destination numbers for automatically updating the database for modifying the forwarding sequence for each of the caller lists.

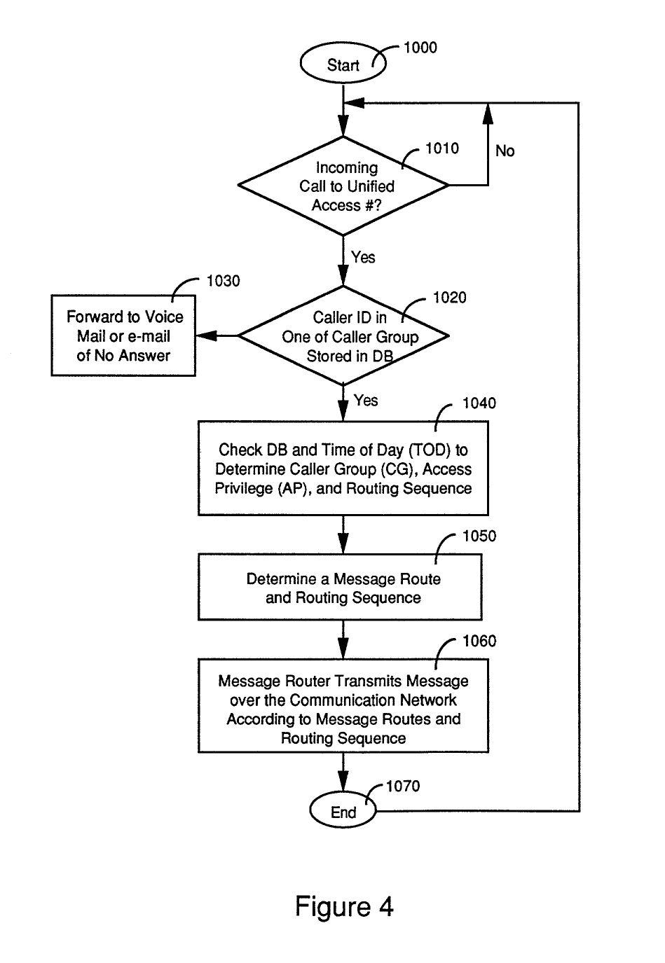

FIG. 4 is a flowchart for illustrating the processing steps of routing the messages on network communication systems such as PSTN or Internet to achieve a sender-specific unified-access delivery process. The process starts (step 1000) by waiting and monitoring an incoming call or messages sent to the unified access number (step 1010). When an incoming call to the unified access number is received, the caller or message sender identification is first checked to determine if the caller/sender is listed in one of the caller groups (CGs) in the database 110 (step 1020). If the caller/sender is not listed in one of the CGs, then the message is forwarded to a voice mail or sent as an electronic mail audio file to the registered owner of the unified access number (step 1030). Once the caller/sender is identified as listed in one of the caller groups, then the time of the day (TOTD) is determined. And, based on the TOTD, the caller/sender's access privilege (AP), forwarding code (FC), routing sequence (RS) and forwarding destination numbers (FDNs) are determined based on the list in database 110 (step 1040). A message route and routing sequence is defined (step 1050) and the message router 125 executes the message route and routing sequence by transmitting the incoming call/message to the registered owner of the unified access number (step 1060). After the message router 125 takes over the transmission of call/message, the process is ended (step 1070) and returns to a waiting and monitoring mode (step 1010) until next incoming call or message is received. These processing steps can be carried out by a unified access management center 120 set up by a telephone company or a message delivery provider or by special unified access message delivery program installed on a personal computer 160 connected to the telephone assigned with unified access number.

In summary, this invention discloses a network communication system. The network communication system includes a sender-specific database 110 connected to a database-enabled message router 125. Tho database is a user editable database that allows a user 105 of the network communication system to edit the database 110 to control sender-specific message routes over the communication system to reach the user 105 on a communication point on the network communication system. In a preferred embodiment, the network communication system further includes a user presence identification means 150 for identifying a user presence at the communication point. This allows for automatically updating the database 110 to control the sender-specific message routes over the communication system to reach the user 105 at the communication point 140-2 on the network communication system. In another preferred embodiment, the network communication system further includes a user computer 160 for storing the sender specific database 110. The user computer 160 is used for interacting with the database enabled message routers 125 to control sender-specific message routes over the communication system to reach the user 105 on a communication point 140-2, or other locations such as 140-1 to 140-6, on the network communication system.

With this invention, a telephone company that handles the routing of different incoming telephone calls has greater flexibility to make use of this message routing database to provide better services. Through registration with the Telephone Company, a database is setup for a particular user assigned with a one-unified-access number. The registered user can then modified the database for controlling an incoming call to forward to different numbers or different devices at different time. Through the database, a telephone user can further control the access for different group of users to different numbers. For the calls made from the telephone number of a group of most important persons, the database would allow the calls to forward to all the numbers sequentially or simultaneously.

This invention also discloses a method for carrying out a network communication. The method includes a step of connecting a sender-specific and user-editable database 110 to a database-enabled message router 125 thus allowing a user 105 of the network communication system to edit the database 110. The user 105 is enabled to control sender-specific message routes over the communication system to reach the user on a communication point on the network communication system. In a preferred embodiment, the method further includes a step of providing a user presence identification means 150 for identifying a user presence at the communication point. This allows for automatically updating the database 110 to control the sender-specific message routes over the communication system to reach the user at the communication point on the network communication system. In another preferred embodiment, the method further includes a step of providing a user computer 160 for storing the sender specific database 110 and for interacting with the database enabled message routers 120. This would enable a user to apply a user computer 160 to control sender-specific message routes over the communication system to reach the user on a communication point on the network communication system.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A unified access telephonic communication system comprising:
a message routing means for controlling and delivering a telephonic message to a plurality of destinations;
a unified access management center comprising a database for entering a unified access number and a plurality of caller lists, each list is associated with a set of forwarding destination numbers for providing to said message routing means to forward a telephone message sent to said unified access number to said forwarding destination numbers;
said unified access management center further comprising an Internet-Web user interface means for a telephone user to edit said database for entering said unified access number and said forwarding destination numbers for said lists or callers;
said unified access management center further comprising a user-access control means for registering said telephone user in providing said unified access number to said database;
said user access control means further comprising a user-logging in means for logging in a registered telephone user for editing said database; and
said unified access management center further comprising a telephone message processor for receiving said telephone message from said unified access number and for processing said telephone message as an electronic mail (e-mail) message.

2. A telephonic communication system comprising:
a message routing means for controlling and delivering a telephonic message to a plurality of destinations;
a database for providing to said message routing means a unified access number and a first forwarding destination number for a first list of callers to forward a telephone message sent to said unified access number from said first list of callers to said first forwarding destination number; and
said database further includes a user interface means for a telephone user to edit said database for entering said unified access number and said first forwarding destination number for said first list of callers.

3. The telephonic communication system of claim 2 further comprising:
a unified access management center for managing said database and for controlling said user interface means.

4. The telephonic communication system of claim 3 wherein:
said unified access management center further comprising a user-access control means for registering said telephone user in providing said unified access number to said database.

5. The telephonic communication system of claim 4 wherein:
said user access control means further comprising a user-logging in means for logging in a registered telephone user for editing said database.

6. The telephonic communication system of claim 2 wherein:
said database further comprising at least a second forwarding destination number associated with a second list of callers for providing to said message routing means for further forwarding said telephone message received from said second list of callers received by said unified access number forwarded to said first forwarding destination number to said second forwarding destination number when said telephone message sent said first forwarding destination number is not answered.

7. The telephonic communication system of claim 2 wherein:
said unified access management center comprising an Internet Web site provided for receiving and processing said telephone message from said unified access number as an electronic mail (e-mail) message.

8. The telephonic communication system of claim 3 wherein:
said unified access management center comprising an Internet Web site and said Internet Web site comprising a user-access control means for registering said telephone user to provide said unified access number to said database.

9. The telephonic communication system of claim 4 wherein:
said unified access management center comprising an Internet Web site and said Internet Web site comprising a user-logging in means for logging in a registered telephone user for editing said database.

10. The telephonic communication system of claim 6 wherein:
said database further comprising a forwarding sequence for each of said caller lists to forward said telephone message received by said unified access number from a caller in each of said caller list to forward said telephone message to different forwarding destination numbers according to said forwarding sequence of each of said caller lists.

11. The telephonic communication system of claim 6 wherein:
said database further comprising a plurality of time-dependent forwarding sequences for each of said caller lists to forward said telephone message received by said unified access number from a caller in each of said caller list to forward said telephone message to different forwarding destination numbers according to said forwarding sequences in each of said caller lists based on a time of the day when said telephone message is received.

12. The telephonic communication system of claim 10 wherein:
said message routing means further including database enabled sequential forwarding means to forward said telephone message sent to said unified access number sequentially to each of said forwarding destination numbers according to said forwarding sequence for each of said caller lists.

13. The telephonic communication system of claim 10 wherein:
said message routing means further including a database enabled simultaneous forwarding means to forward said telephone message from a caller in a simultaneous forwarding caller list simultaneously to all of said forwarding destination numbers list in the database.

14. The telephonic communication system of claim 2 wherein:
said database further comprising at least a forwarding destination e-mail address for providing to said message routing means for forwarding said telephone message sent to said unified access number to said forwarding destination e-mail address.

15. The telephonic communication system of claim 2 wherein:
said database further comprising at least a forwarding destination universal resource locator (URL) for providing to said message routing means for forwarding said telephone message sent to said unified access number to said forwarding destination URL.

16. The telephonic communication system of claim 10 further comprising:
a user presence identifying means for identifying a user's presence at a location of one of said forwarding destination numbers for automatically updating said database for modifying said forwarding sequence for each of said caller lists.

17. A network communication system comprising:
a sender-specific database connected to a database-enabled message router wherein said database is a user editable database that allows a user of said network communication system to edit said database to control sender-specific message routes over said communication system to reach said user on a communication point on said network communication system.

18. The network communication system of claim 17 further comprising:
a user presence identification means for identifying a user presence at said communication point for automatically updating said database to control said sender-specific message routes over said communication system to reach said user at said communication point on said network communication system.

19. The network communication system of claim 17 further comprising:
a user computer for storing said sender specific database and for interacting with said data-base enabled message routers to control sender-specific message routes over said communication system to reach said user on a communication point on said network communication system.

20. A method for carrying out a network communication comprising:
connecting a sender-specific and user-editable database to a database-enabled message router thus allowing a user of said network communication system to edit said database to control sender-specific message routes over said communication system to reach said user on a communication point on said network communication system.

21. The method of claim 20 further comprising:
providing a user presence identification means for identifying a user presence at said communication point for automatically updating said database to control said sender-specific message routes over said communication system to reach said user at said communication point on said network communication system.

22. The method of claim 20 further comprising:
providing a user computer for storing said sender specific database and for interacting with said data-base enabled message routers to control sender-specific message routes over said communication system to reach said user on a communication point on said network communication system.
